(19) United States
(12) Patent Application Publication
(10) Pub. No.: US 2016/0117856 A1
(43) Pub. Date: Apr. 28, 2016

(54) POINT CLOUD PROCESSING METHOD AND COMPUTING DEVICE USING SAME

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); SU-YING FU, Shenzhen (CN); ZONG-TAO YANG, Shenzhen (CN)

(21) Appl. No.: 14/750,252

(22) Filed: Jun. 25, 2015

(30) Foreign Application Priority Data
Oct. 28, 2014 (CN) 201410593967.5

(51) Int. Cl. G06T 15/10; G06T 17/20

(52) U.S. Cl. CPC G06T 15/10; G06T 17/20; G06T 2200/04

(57) ABSTRACT

A point cloud processing method is provided. The method includes: depicting, at a computing device, a three-dimensional image based on a point cloud data set; converting, at the computing device, the three-dimensional image to a two-dimensional image; dragging, at the computing device, a brush to form a coverage are; determining, at the computing device, whether a point is within the coverage area by comparing coordinates of each point in the two-dimensional image with coordinates of area boundary of the coverage area; and painting, at the computing device, the point within the coverage area to specific color.

### FIELD

The subject matter herein generally relates to an image processing method, especially relates to a point cloud processing method and a computing device using the same.

### BACKGROUND

Three-Dimensional (3D) point cloud data acquired from a scanning device might include miscellaneous noise points due to various actors, for example, quality of scanning device, illumination, environment, and product scanned by the scanning device. The miscellaneous noise points generally result in blurred product images, therefore reducing accuracy of various product test based on the blurred product images. Therefore, there is a need for a point cloud processing method capable of reducing miscellaneous noise points.

### BRIEF DESCRIPTION OF THE DRAWINGS

Implementations of the present technology will now be described, by way of example only, with reference to the attached figures.

FIG. 1 is a block diagram of an exemplary embodiment of a computing device with a point cloud processing system.

FIG. 2 is a flowchart of an exemplary embodiment of a point cloud processing method.

FIG. 3 is a diagrammatic view of an exemplary embodiment of a brush coverage area.

FIG. 4 is a diagrammatic view of an exemplary embodiment of an area boundary of coverage area.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

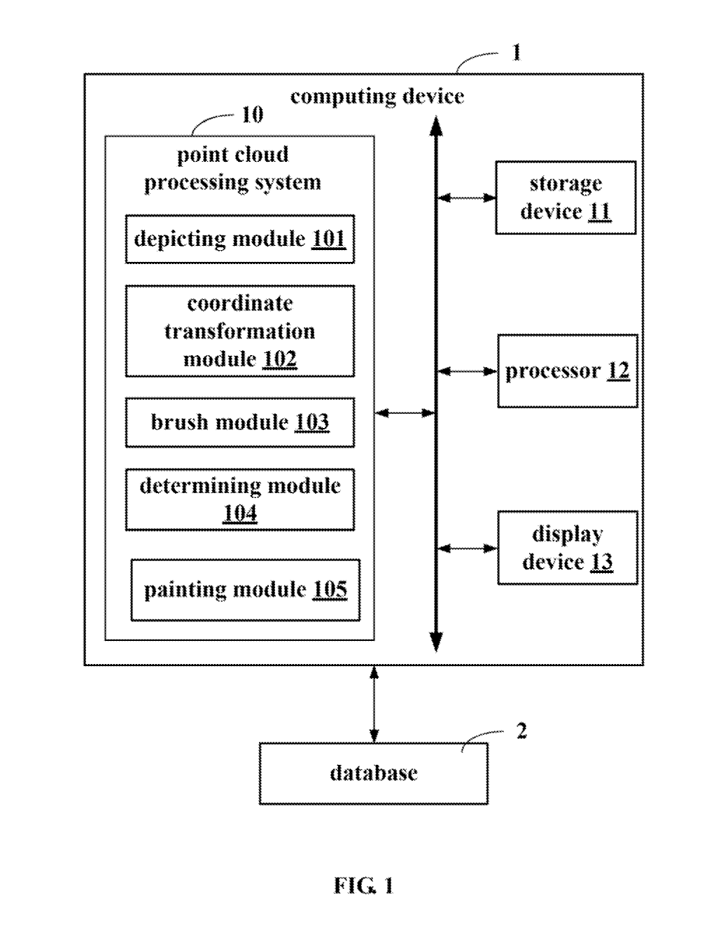

FIG. 1 illustrates a diagram of an exemplary embodiment of a computing device 1 with a point cloud processing system 10. In the example embodiment, the computing device 1 can be a personal computer (PC), a workstation computer, a notebook, a server or other computing device. The computing device 1 can be equipped with at least one operation system, for example, Windows® operation system or Linux® operation system, and one or more applications, for example, graphics system like computer aided design (CAD) graphics system. The computing device 1 can coupled with a database 2 through a link. The link can be cable, or wired network or wireless network, for example, wide area network (WAN), local area network (LAN). The database 2 can be configured to store at least one point cloud data set of at least one object, for example, a mouse. Each point cloud data set defines coordinates of a plurality of pixel points and can construe a three-dimensional (3D) image in a model space system, for example, CAD graphics system.

The computing device 1 can include, but not limited to, a storage device 11, a processor 12, and a display device 13. The storage device 11 can be configured to store data related to operation of the computing device 1. The processor 12 can be configured to control operation of the computing device 1.

The storage device 11 can be an internal storage unit of the computing device 1, for example, a hard disk or memory, or a pluggable memory, for example, Smart Media Card, Secure Digital Card, Flash Card. In at least one embodiment, the storage device 11 can include two or more storage devices such that one storage device is an internal storage unit and the other storage device is a pluggable memory. The processor 12 can be a central processing unit (CPU), a microprocessor, or other data processor chip that performs functions of the computing device 1. The display device 13 can be a liquid crystal display or other currently available display.

Referring to FIG. 1, the point cloud processing system 10 can include computerized instructions in the form of one or more programs that can be stored in the storage device 40 and executed by the processor 50. In the embodiment, the point cloud processing system 10 can be integrated in the processor 50. In at least one embodiment, the point cloud processing system 10 can be independent from the processor 50. Referring to FIG. 1, the system 10 can include one or more modules, for example, a depicting module 101, a coordinate transformation module 102, a brush module 103, a determining module 104, and a painting module 105. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The depicting module 101 can be configured to depict a 3-D image based on a point cloud data set. The point cloud data set can define coordinates of a plurality of points in world coordinate system.

The coordinate transformation module 102 can be configured to convert the 3-D image to a two-dimensional (2-D) image by coordinate conversion. Any currently available coordinate conversion method for converting a 3-D image to a 2-D image can be used.

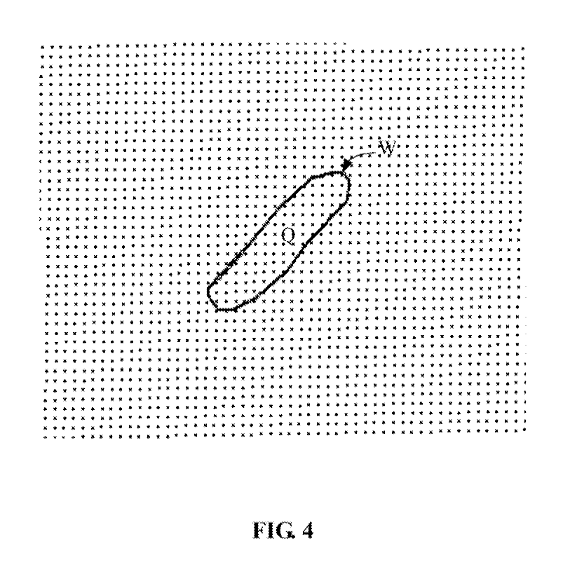

The brush module 103 can be configured to drag a brush in the 2-D image to form a coverage area which has an area boundary of the coverage area as illustrated in FIG. 4.

The determining module 104 can be configured to determine whether a point of the 2-D image is within the coverage area by comparing coordinates of the point with the coordinates of the area boundary of the coverage area.

The painting module 105 can be configured to paint the point within the coverage area to specific color, for example, red.

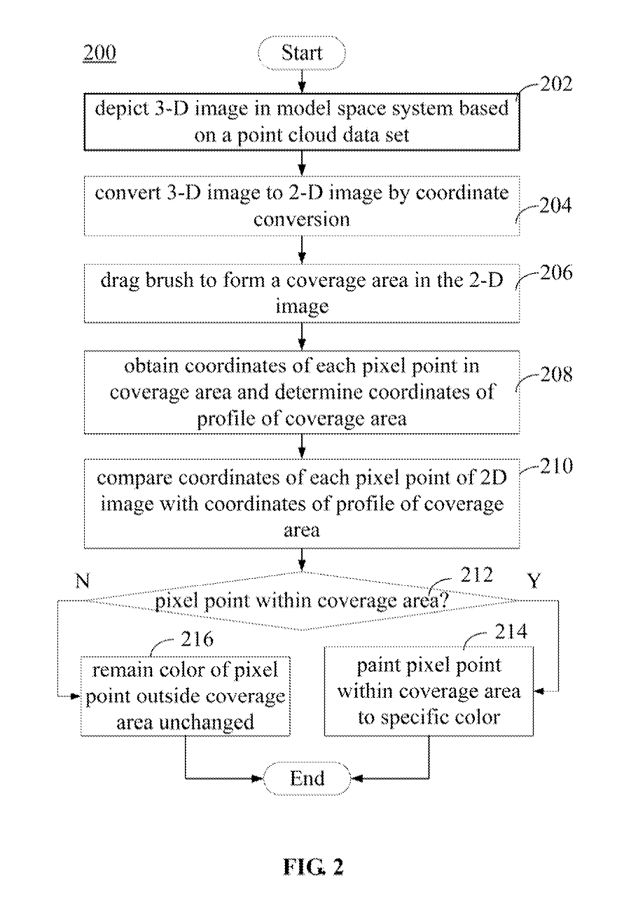

Referring to FIG. 2, a flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of the figure is referenced in explaining example method 300. Each block shown in FIG. 2 represents one or more processes, methods or subroutines, carried out in the exemplary method 300. Furthermore, the illustrated order of blocks is by example only and the order of the blocks can change according to the present disclosure. Additional blocks may be added or fewer blocks may be utilized, without departing from this disclosure. The exemplary point cloud processing method 200 is illustrated in FIG. 2. The exemplary method 200 can be executed by a computing device, and can begin at block 202. The computing device can include a storage device configured to store related information.

At block 202, the computing device depicts a 3-D image in a model space system based on a point-cloud data set. In detail, the computing device opens the point-cloud data set in the model space system equipped on the computing device, for example, computer aided design system (CAD). The point cloud data set defines a plurality of points, each point having a 3-D coordinates in a 3D coordinate system, for example, a world coordinate system. Then, the computing device depicts each point in the model space system based on the 3-D coordinates of each point, thus generating the 3-D image. The 3-D image consists of the plurality of points. A common instance of a 3D Coordinate System is the Cartesian coordinate system where three X, Y, Z axes perpendicular to each other and meeting each other at an origin point (0, 0, 0) are used to parameterize the 3-dimensional space.

At block 204, the computing device converts the 3-D image to a 2-D image by coordinate conversion. An exemplary embodiment of coordinate conversion can include: conversion from the world coordinate system to the camera coordinate system, conversion from the camera coordinate system to projection plane coordinate system, and from projection plane coordinate system to image plane coordinate system. After the image data in the image coordinate system is calculated, the 2-D image can be correctly depicted.

Firstly, an exemplary conversion from the world coordinate system to the camera coordinate system can be illustrated herein. Both the world coordinate system and the camera coordinate system are 3-D coordinate system. The camera coordinate system can be treated as a result of translation and rotation of the world coordinate system. So that, the conversion from the world coordinate system to the camera coordinate system can be implemented based on an expression 1.1:

$$[ \begin{matrix}{X}_{C} \\ {Y}_{C} \\ {Z}_{C} \\ 1\end{matrix} ] = [ \begin{matrix}R & T \\ {0}^{T} & 1\end{matrix} ] [ \begin{matrix}{X}_{W} \\ {Y}_{W} \\ {Z}_{W} \\ 1\end{matrix} ] = {M}_{1} [ \begin{matrix}{X}_{W} \\ {Y}_{W} \\ {Z}_{W} \\ 1\end{matrix} ] \\ R = [ \begin{matrix}cos ϕcos θ & sin ϕcos θ & - sin θ \\ \begin{matrix}- sin ϕcosφ + \\ cos ϕsinθcos φ\end{matrix} & \begin{matrix}cos ϕcosφ + \\ sin ϕsinθ sini φ\end{matrix} & cos θsinφ \\ \begin{matrix}sin ϕsinφ + \\ cos ϕsin θcos φ\end{matrix} & \begin{matrix}- cos ϕsin φ + \\ sin ϕsinθsinφ\end{matrix} & cos θsonφ\end{matrix} ] ; \\ T = {[ {T}_{x} , {T}_{y} , {T}_{z} ]}^{T} \qquad ( 1.1 )$$

wherein: [X_{W},Y_{W},Z_{W},1]^{T} represents coordinates of a point P in the world coordinate system; [X_{C}, Y_{C}, Z_{C},1]^{T} represents coordinates of a point P in the camera coordinate system; R represents 3*3 orthogonal matrixes, θ, , φ are Euler angles of rotation and respectively represent angles of yaw, pitch, and roll; Tx, Ty, Tz respectively represent displacement in X, Y, Z axis; Ml is a 4*4 matrix.

Then, an exemplary conversion from the camera coordinate system to the projection coordinate system can be illustrated herein. The projection coordinate system is a 2-D coordinate system and is a projection of the camera coordinate system. The conversion from the world coordinate system to the camera coordinate system can be implemented based on an expression 1.2:

$${Z}_{c} = [ \begin{matrix}x \\ y \\ 1\end{matrix} ] = [ \begin{matrix}f & 0 & 0 & 0 \\ 0 & f & 0 & 0 \\ 0 & 0 & 1 & 0\end{matrix} ] [ \begin{matrix}{X}_{c} \\ {Y}_{c} \\ {Z}_{c} \\ 1\end{matrix} ] \qquad ( 1.2 )$$

wherein: (x, y) represents coordinates of a point P in the projection coordinate system;

$$x = \frac{{fX}_{c}}{{Z}_{c}} , \\ {y = \frac{{fY}_{c}}{{Z}_{c}} ; \\ [ {X}_{c} , {Y}_{c} , {Z}_{c} ]}^{T}$$

represents coordinates of the point P in the camera coordinate system; f represents a displacement of the projection plane in the Z axis of the camera coordinate system.

Then, an exemplary conversion from the projection coordinate system to the image coordinate system can be illustrated herein. The image coordinate system is a 2-D coordinate system and can be treated as a result of scaling and translation of the projection coordinate system. The conversion from the world coordinate system to the camera coordinate system can be implemented based on an expression 1.3:

$$[ \begin{matrix}μ \\ v \\ 1\end{matrix} ] = [ \begin{matrix}\frac{1}{{μ}_{x}} & - \frac{1}{{μ}_{x}} cot θ & {μ}_{0} \\ 0 & \frac{1}{{μ}_{y}} \frac{1}{sin θ} & {v}_{0} \\ 0 & 0 & 1\end{matrix} ] [ \begin{matrix}x \\ y \\ 1\end{matrix} ] \qquad ( 1.3 )$$

wherein: (μ,v) represents coordinates of a point P in the image coordinate system; (x, y) represents coordinates of a point P in the projection coordinate system; (μ₀,v₀) represents coordinates of origin of the projection coordinate system in the image coordinate system; μₓ,μ_{y} represent coordinates of an area boundary of 2-D image formed in the projection plane in the image coordinate system.

The conversion from the world coordinate system to the image coordinate system can be derived as the following expression 1.4 based on the above expressions 1.1-1.3:

$$\begin{matrix}{Z}_{c} [ \begin{matrix}μ \\ v \\ 1\end{matrix} ] = [ \begin{matrix}\frac{1}{{μ}_{x}} & - \frac{1}{{μ}_{x}} cot θ & {μ}_{0} \\ 0 & \frac{1}{{μ}_{y}} \frac{1}{sin θ} & {v}_{0} \\ 0 & 0 & 1\end{matrix} ] [ \begin{matrix}f & 0 & 0 & 0 \\ 0 & f & 0 & 0 \\ 0 & 0 & 1 & 0\end{matrix} ] [ \begin{matrix}R & T \\ 0 & 1\end{matrix} ] [ \begin{matrix}{X}_{W} \\ {Y}_{W} \\ {Z}_{W} \\ 1\end{matrix} ] \\ = [ \begin{matrix}{f}_{x} & - {f}_{x} cot θ & {μ}_{0} & 0 \\ 0 & {f}_{y} \frac{1}{sin θ} & {v}_{0} & 0 \\ 0 & 0 & 1 & 0\end{matrix} ] [ \begin{matrix}R & T \\ {0}^{T} & 1\end{matrix} ] [ \begin{matrix}{X}_{w} \\ {Y}_{w} \\ {Z}_{w} \\ 1\end{matrix} ]\end{matrix} \qquad ( 1.4 )$$

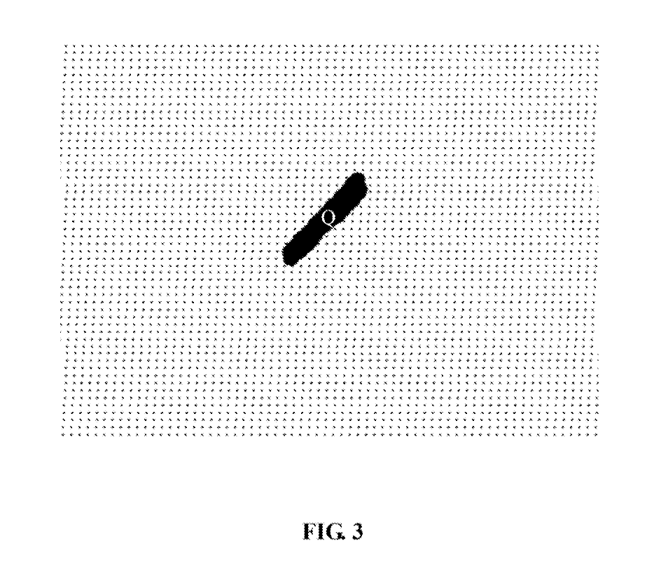

At block 206, the computing device drags a brush to form a coverage area in the 2-D image in response to user operation. Referring to FIG. 3, an exemplary coverage area Q is illustrated, and referring to FIG. 4, an exemplary area boundary W of the coverage area Q is illustrated.

At block 208, the computing device obtains coordinates of each pixel point in the coverage area Q and determines coordinates of the area boundary W of the coverage area. In at least one exemplary embodiment, the obtained coordinates can be stored in the storage device.

At block 210, the computing device compares coordinates of each pixel point of the 2-D image with the coordinates of the area boundary of the coverage area.

At block 212, the computing device determines whether a random point A of the 2-D image is within the coverage area. For example, if a random point A of the 2-D image has a coordinate (Xa, Ya), the coordinates of the area boundary of the 2-D image have a maximum value and a minimized value in X and Y axis: Xₘₐₓ, Xₘᵢₙ, Yₘₐₓ, Yₘᵢₙ. If the coordinate (Xa, Ya) satisfies: Xₘᵢₙ≦Xₐ≦Xₘₐₓ and Yₘᵢₙ≦Yₐ≦Yₘₐₓ, the random point A can be determined to be within the coverage area Q, otherwise, the random point A can be determined to be outside the coverage area Q. If the random point A is determined to be within the coverage area Q, the process goes to block 214, otherwise, the process goes to block 216.

At block 214, the computing device paints the pixel point within the coverage area to specific color, for example, red.

At block 126, the computing device remains the current color of the pixel point outside the coverage area unchanged.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A point cloud processing method, comprising:
depicting, at a computing device, a three-dimensional image based on a point cloud data set;
converting, at the computing device, the three-dimensional image to a two-dimensional image;
dragging, at the computing device, a brush to form a coverage are;
determining, at the computing device, whether a point is within the coverage area by comparing coordinates of each point in the two-dimensional image with coordinates of area boundary of the coverage area; and
painting, at the computing device, the point within the coverage area to specific color.

2. The method according to claim 1, wherein if coordinate (Xa, Ya) of a random point A satisfies: Xₘᵢₙ≦Xₐ≦Xₘₐₓ and Yₘᵢₙ≦Yₐ≦Yₘₐₓ, the random point A is determined to be within the coverage area, wherein Xₘₐₓ, Xₘᵢₙ respectively represent a maximum value and a minimized value in X and Y axis of the coordinates of the area boundary of the 2-D image.

3. The method according to claim 1, wherein if coordinate (Xa, Ya) of a random point A does not satisfy: Xₘᵢₙ≦Xₐ≦Xₘₐₓ and Yₘᵢₙ≦Yₐ≦Yₘₐₓ, the random point A is determined to be outside the coverage area, wherein Xₘₐₓ, Xₘᵢₙ respectively represent a maximum value and a minimized value in X and Y axis of the coordinates of the area boundary of the 2-D image.

4. The method according to claim 1, wherein converting from the three-dimensional image to the two-dimensional image is performed by coordinate conversion which comprises coordinate conversion from a world coordinate system to an image coordinate system.

5. The method according to claim 4, wherein the conversion comprises converting from a world coordinate system to a camera coordinate system, coordinate conversion from the camera coordinate system to a projection coordinate system, and conversion from the projection coordinate system to an image coordinate system.

6. A computing device, comprising:
a storage device configured to store instructions; and
a processor configured to execute instructions to cause the processor to:
depict a three-dimensional image based on a point cloud data set;
convert the three-dimensional image to a two-dimensional image;
drag a brush to form a coverage are;
determine whether a point is within the coverage area by comparing coordinates of each point in the two-dimensional image with coordinates of area boundary of the coverage area; and
paint the point within the coverage area to specific color.

7. The computing device according to claim 6, wherein if coordinate (Xa, Ya) of a random point A satisfies: Xₘᵢₙ≦Xₐ≦Xₘₐₓ and Yₘᵢₙ≦Yₐ≦Yₘₐₓ, the random point A is determined to be within the coverage area, wherein Xₘₐₓ, Xₘᵢₙ respectively represent a maximum value and a minimized value in X and Y axis of the coordinates of the area boundary of the 2-D image.

8. The computing device according to claim 6, wherein if coordinate (Xa, Ya) of a random point A does not satisfy: Xₘᵢₙ≦Xₐ≦Xₘₐₓ and Yₘᵢₙ≦Yₐ≦Yₘₐₓ, the random point A is determined to be outside the coverage area, wherein Xₘₐₓ, Xₘᵢₙ respectively represent a maximum value and a minimized value in X and Y axis of the coordinates of the area boundary of the 2-D image.

9. The computing device according to claim 6, wherein converting from the three-dimensional image to the two-dimensional image is performed by coordinate conversion which comprises coordinate conversion from a world coordinate system to an image coordinate system.

10. The computing device according to claim 6, wherein the conversion comprises converting from a world coordinate system to a camera coordinate system, coordinate conversion from the camera coordinate system to a projection coordinate system, and conversion from the projection coordinate system to an image coordinate system.

11. The computing device according to claim 6, wherein the instructions further cause the processor to: store the coordinates of the three-dimensional image in the storage device.

12. The computing device according to claim 6, wherein the instructions further cause the processor to: store the coordinates of the two-dimensional image in the storage device.
